(19) United States
(12) Patent Application Publication
(10) Pub. No.: US 2024/0411689 A1
(43) Pub. Date: Dec. 12, 2024

(54) METHOD FOR PERFORMING GARBAGE COLLECTION MANAGEMENT OF MEMORY DEVICE WITH AID OF DEDICATED INFORMATION CONTROL, MEMORY CONTROLLER, MEMORY DEVICE AND ELECTRONIC DEVICE

(71) Applicant: Silicon Motion, Inc., Hsinchu County (TW)

(72) Inventor: Wei-Chi Hsu, Taoyuan City (TW)

(73) Assignee: Silicon Motion, Inc., Hsinchu County (TW)

(21) Appl. No.: 18/674,901

(22) Filed: May 26, 2024

(30) Foreign Application Priority Data
Jun. 8, 2023 (TW) 112121432

(51) Int. Cl. G06F 12/02

(52) U.S. Cl. CPC G06F 12/0253; G06F 12/0292

(57) ABSTRACT

A method for performing garbage collection (GC) management of a memory device with aid of dedicated information control and associated apparatus are provided. The method may include: receiving at least one first command, and performing at least one accessing operation on a non-volatile (NV) memory according to the at least one first command; and executing a GC procedure to start performing GC on the NV memory, for example: dividing a memory region of a volatile memory into multiple sub-regions to be multiple dedicated memory regions; selecting multiple source blocks; comparing address mapping tables to generate and store valid-data location information in the multiple dedicated memory regions, respectively; and performing multiple GC operations according to the valid-data location information respectively stored in the multiple dedicated memory regions.

### BACKGROUND OF THE INVENTION

### 1. Field of the Invention

The present invention relates to memory control, and more particularly, to a method for performing garbage collection (GC) management of a memory device with aid of dedicated information control and associated apparatus such as a memory controller of the memory device, the memory device and an electronic device comprising the memory device.

### 2. Description of the Prior Art

According to the related art, a memory device may perform GC to try releasing a portion of storage space for further use, which may reduce overall performance. More particularly, during access in response to a host request, a controller integrated circuit (IC) of the memory device may under certain circumstances spend an excessive amount of time performing internal operations of the memory device. Some suggestions may have been proposed in the related art to try solving this problem, but further problems such as certain side effects may be introduced. Thus, a novel method and associated architecture are needed for solving the problems without introducing any side effect or in a way that is less likely to introduce a side effect.

### SUMMARY OF THE INVENTION

It is therefore an objective of the present invention to provide a method for performing GC management of a memory device with aid of dedicated information control and associated apparatus such as a memory controller of the memory device, the memory device and an electronic device comprising the memory device, in order to solve the above-mentioned problems.

At least one embodiment of the present invention provides a method for performing GC management of a memory device with aid of dedicated information control, where the method can be applied to a memory controller of the memory device. The memory device may comprise the memory controller and a non-volatile (NV) memory, the NV memory may comprise at least one NV memory element (e.g., one or more NV memory elements), and the aforementioned at least one NV memory element may comprise a plurality of blocks. The method may comprise: utilizing the memory controller to receive at least one first command from a host device through a transmission interface circuit within the memory controller, and perform at least one accessing operation on the NV memory according to the at least one first command, wherein the at least one first command indicates at least one write request from the host device; and executing a GC procedure to start performing GC on the NV memory. For example, the GC procedure may comprise: dividing a memory region of a volatile memory within the memory controller into multiple sub-regions according to a number of the at least one NV memory element to be multiple dedicated memory regions, wherein the number of the at least one NV memory element is greater than one; selecting multiple source blocks from the plurality of blocks; reading respective physical-to-logical (P2L) address mapping tables of the multiple source blocks; reading at least one latest logical-to-physical (L2P) address mapping table within the NV memory according to the respective P2L address mapping tables of the multiple source blocks; comparing the respective P2L address mapping tables of the multiple source blocks and the at least one latest L2P address mapping table to generate and store valid-data location information in the multiple dedicated memory regions, respectively, for indicating locations of per-NV-memory-element valid data; and performing multiple GC operations according to said valid-data location information respectively stored in the multiple dedicated memory regions, wherein at least one portion of GC operations among the multiple GC operations are performed in parallel processing.

In addition to the above method, the present invention also provides a memory controller of a memory device, where the memory device may comprise the memory controller and a NV memory. The NV memory may comprise at least one NV memory element (e.g., one or more NV memory elements), and the aforementioned at least one NV memory element may comprise a plurality of blocks. In addition, the memory controller comprises a processing circuit that is arranged to control the memory controller according to a plurality of host commands from a host device, to allow the host device to access the NV memory through the memory controller, wherein the processing circuit is arranged to perform GC management of the memory device with aid of dedicated information control. The memory controller further comprises a transmission interface circuit, and the transmission interface circuit is arranged to perform communications with the host device. For example, the memory controller may be arranged to receive at least one first command from the host device through the transmission interface circuit within the memory controller, and perform at least one accessing operation on the NV memory according to the at least one first command, wherein the at least one first command indicates at least one write request from the host device; and the memory controller executes a GC procedure to start performing GC on the NV memory. More particularly, the GC procedure may comprise: dividing a memory region of a volatile memory within the memory controller into multiple sub-regions according to a number of the at least one NV memory element to be multiple dedicated memory regions, wherein the number of the at least one NV memory element is greater than one; selecting multiple source blocks from the plurality of blocks; reading respective physical-to-logical (P2L) address mapping tables of the multiple source blocks; reading at least one latest logical-to-physical (L2P) address mapping table within the NV memory according to the respective P2L address mapping tables of the multiple source blocks; comparing the respective P2L address mapping tables of the multiple source blocks and the at least one latest L2P address mapping table to generate and store valid-data location information in the multiple dedicated memory regions, respectively, for indicating locations of per-NV-memory-element valid data; and performing multiple GC operations according to said valid-data location information respectively stored in the multiple dedicated memory regions, wherein at least one portion of GC operations among the multiple GC operations are performed in parallel processing.

In addition to the method mentioned above, the present invention also provides the memory device comprising the memory controller mentioned above, wherein the memory device comprises the NV memory and the memory controller. The NV memory is configured to store information, and the memory controller is coupled to the NV memory, and is configured to control operations of the memory device.

In addition to the method mentioned above, the present invention also provides an electronic device. The electronic device may comprise the memory device mentioned above, and may further comprise the host device that is coupled to the memory device. The host device may comprise at least one processor that is arranged for controlling operations of the host device; and a power supply circuit that is coupled to the at least one processor, and is arranged for providing power to the at least one processor and the memory device. In addition, the memory device may provide the host device with storage space.

According to some embodiments, the apparatus may comprise at least one portion (e.g., a portion or all) of the electronic device. For example, the apparatus may comprise the memory controller within the memory device. For another example, the apparatus may comprise the memory device. For yet another example, the apparatus may comprise the host device. In some examples, the apparatus may comprise the electronic device.

According to some embodiments, the memory controller of the memory device may control the operations of the memory device according to the method, and the memory device may be installed in the electronic device. In addition, the memory device may store data for the host device. The memory device may read the stored data in response to a host command from the host device, and provide the host device with the data read from the NV memory.

The present invention method and apparatus can guarantee that the memory device can operate properly in various situations, and more particularly, divide at least one portion of blocks among the plurality of blocks of the NV memory into blocks respectively corresponding to multiple channels, and when performing GC operations, use first blocks corresponding to a first channel together as first source blocks of a first GC operation and determine a first target block corresponding to the first channel to be a first destination block of the first GC operation, and use second blocks corresponding to a second channel together as second source blocks of a second GC operation and determine a second target block corresponding to the second channel to be a second destination block of the second GC operation, to make the GC operations proceed according to the multiple channels, respectively, in order to enhance overall GC performance. In addition, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to an embodiment of the present invention.

FIG. 2 illustrates a NV-memory-element-unaware block selection control scheme.

FIG. 3A illustrates a first part of a timing diagram of the NV-memory-element-unaware block selection control scheme shown in FIG. 2.

FIG. 3B illustrates a second part of the timing diagram of the NV-memory-element-unaware block selection control scheme shown in FIG. 2.

FIG. 3C illustrates a third part of the timing diagram of the NV-memory-element-unaware block selection control scheme shown in FIG. 2.

FIG. 3D illustrates a fourth part of the timing diagram of the NV-memory-element-unaware block selection control scheme shown in FIG. 2.

FIG. 3E illustrates a fifth part of the timing diagram of the NV-memory-element-unaware block selection control scheme shown in FIG. 2.

FIG. 3F illustrates a sixth part of the timing diagram of the NV-memory-element-unaware block selection control scheme shown in FIG. 2.

FIG. 4 illustrates a NV-memory-element-aware block selection control scheme of a method for performing GC management of a memory device with aid of dedicated information control according to an embodiment of the present invention.

FIG. 5A illustrates a first part of a timing diagram of the NV-memory-element-aware block selection control scheme shown in FIG. 4.

FIG. 5B illustrates a second part of the timing diagram of the NV-memory-element-aware block selection control scheme shown in FIG. 4.

FIG. 5C illustrates a third part of the timing diagram of the NV-memory-element-aware block selection control scheme shown in FIG. 4.

FIG. 6 illustrates a comparison control scheme of the method according to an embodiment of the present invention.

FIG. 7A illustrates a NV-memory-element-dedicated memory region control scheme of the method according to an embodiment of the present invention.

FIG. 7B illustrates some implementation details of the NV-memory-element-dedicated memory region control scheme shown in FIG. 7A.

FIG. 7C illustrates some implementation details of the NV-memory-element-dedicated memory region control scheme shown in FIG. 7A.

FIG. 8 illustrates a working flow of the method according to an embodiment of the present invention.

FIG. 9A illustrates an example of multiple dedicated memory regions involved with the method.

FIG. 9B illustrates an example of multiple die-dedicated memory regions involved with the method.

FIG. 9C illustrates an example of multiple chip-dedicated memory regions involved with the method.

### DETAILED DESCRIPTION

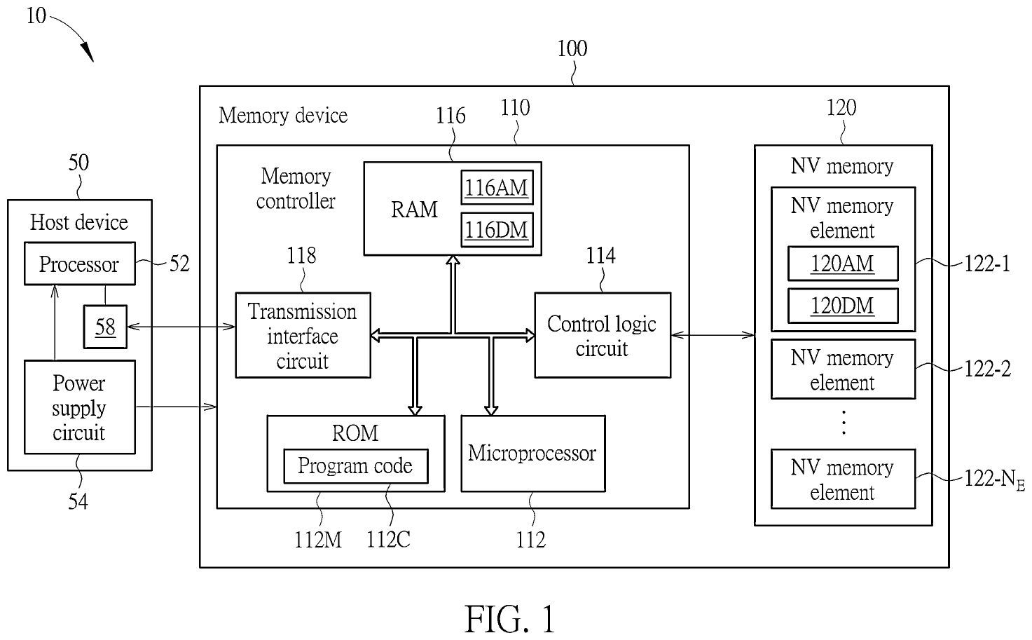

FIG. 1 is a diagram of an electronic device according to an embodiment of the present invention, where the electronic device 10 may comprise a host device 50 and a memory device 100. The host device 50 may comprise at least one processor (e.g., one or more processors) which may be collectively referred to as the processor 52, a power supply circuit 54, and a transmission interface circuit 58, where the processor 52 and the transmission interface circuit 58 may be coupled to each other through a bus, and may be coupled to the power supply circuit 54 to obtain power. The processor 52 may be arranged to control operations of the host device 50, and the power supply circuit 54 may be arranged to provide the processor 52, the transmission interface circuit 58, and the memory device 100 with power, and output one or more driving voltages to the memory device 100, where the memory device 100 may provide the host device 50 with storage space, and may obtain the one or more driving voltages from the host device 50, to be the power of the memory device 100. Examples of the host device 50 may include, but are not limited to: a multifunctional mobile phone, a tablet computer, a wearable device, and a personal computer such as a desktop computer and a laptop computer. Examples of the memory device 100 may include, but are not limited to: a portable memory device (e.g., a memory card conforming to the SD/MMC, CF, MS or XD specification), a solid state drive (SSD), and various types of embedded memory devices (e.g., an embedded memory device conforming to the UFS or eMMC specification). According to this embodiment, the memory device 100 may comprise a controller such as a memory controller 110, and may further comprise a non-volatile (NV) memory 120, where the controller is arranged to access the NV memory 120, and the NV memory 120 is arranged to store information. The NV memory 120 may comprise at least one NV memory element (e.g., one or more NV memory elements), such as a plurality of NV memory elements 122-1, 122-2, . . . and 122-N_{E}, where “N_{E}” may represent a positive integer that is greater than one. For example, the NV memory 120 may be a flash memory, and the plurality of NV memory elements 122-1, 122-2, . . . and 122-N_{E} may be a plurality of flash memory chips {CHIP} (e.g., the chips CHIP(1), CHIP(2), . . . and CHIP(N_{E})) or a plurality of flash memory dies {DIE} (e.g., the dies DIE(1), DIE(2), . . . and DIE(N_{E})), respectively, but the present invention is not limited thereto.

As shown in FIG. 1, the memory controller 110 may comprise a processing circuit such as a microprocessor 112, a storage unit such as a read only memory (ROM) 112M, a control logic circuit 114, a RAM 116 (which may be implemented by way of SRAM, for example), and a transmission interface circuit 118, where at least one portion (e.g., a portion or all) of the above components may be coupled to one another via a bus. The RAM 116 may be arranged to provide the memory controller 110 with internal storage space (for example, may temporarily store information), but the present invention is not limited thereto. In addition, the ROM 112M of this embodiment is arranged to store a program code 112C, and the microprocessor 112 is arranged to execute the program code 112C to control the access of the NV memory 120. Please note that, the program code 112C may also be stored in the RAM 116 or any type of memory. Additionally, the control logic circuit 114 may be arranged to control the NV memory 120. The control logic circuit 114 may comprise an error correction code (ECC) circuit (not shown in FIG. 1), which may perform ECC encoding and ECC decoding, to protect data, and/or perform error correction. The transmission interface circuit 118 may conform to one or more communications specifications among various communications specifications (e.g., the Serial Advanced Technology Attachment (SATA) specification, Universal Serial Bus (USB) specification, Peripheral Component Interconnect Express (PCIe) specification, Non-Volatile Memory Express (NVMe) specification, embedded Multi Media Card (eMMC) specification, and Universal Flash Storage (UFS) specification), and may perform communications with the host device 50 (e.g., the transmission interface circuit 58) according to the one or more communications specifications for the memory device 100. Similarly, the transmission interface circuit 58 may conform to the one or more communications specifications, and may perform communications with the memory device 100 (e.g., the transmission interface circuit 118) according to the one or more communications specifications for the host device 50.

In this embodiment, the host device 50 may transmit a plurality of host commands and corresponding logical addresses to the memory controller 110, to access the NV memory 120 within the memory device 100, indirectly. The memory controller 110 receives the plurality of host commands and the logical addresses, and translates the plurality of host commands into memory operation commands (which may be referred to as operation commands, for brevity), respectively, and further controls the NV memory 120 with the operation commands to perform reading or writing/programming upon the memory units or data pages of specific physical addresses within the NV memory 120, where the physical addresses can be associated with the logical addresses. For example, the memory controller 110 may generate or update at least one logical-to-physical (L2P) address mapping table to manage the relationship between the physical addresses and the logical addresses, where the NV memory 120 may store a global L2P address mapping table 120AM, for the memory controller 110 to control the memory device 100 to access data in the NV memory 120, but the present invention is not limited thereto. In addition, the memory controller 110 may generate or update at least one dedicated GC (DGC) management table such as a DGC management table 120DM, and the NV memory 120 may store the DGC management table 120DM. The memory controller 110 may generate or update GC-management-related information in the DGC management table 120DM for managing GC operations.

For better comprehension, the global L2P address mapping table 120AM and the DGC management table 120DM may be located in a predetermined region within the NV memory element 122-1, such as a system region, but the present invention is not limited thereto. For example, the global L2P address mapping table 120AM may be divided into a plurality of local L2P address mapping tables, and the local L2P address mapping tables may be stored in one or more of the NV memory elements 122-1, 122-2, . . . and 122-N_{E}, and more particularly, may be stored in the NV memory elements 122-1, 122-2, . . . and 122-N_{E}, respectively. When there is a needed, the memory controller 110 may load at least one portion (e.g., a portion or all) of the global L2P address mapping table 120AM into the RAM 116 or other memories. For example, the memory controller 110 may load a local L2P address mapping table among the plurality of local L2P address mapping tables into the RAM 116 to be a temporary L2P address mapping table 116AM, for accessing data in the NV memory 120 according to the local L2P address mapping table which is stored as the temporary L2P address mapping table 116AM, but the present invention is not limited thereto. The memory controller 110 may generate or update address mapping information in the temporary L2P address mapping table 116AM, and update the global L2P address mapping table 120AM according to the latest address mapping information in the temporary L2P address mapping table 116AM. In addition, the memory controller 110 may load the DGC management table 120DM into the RAM 116 or other memories. For example, the memory controller 110 may load the DGC management table 120DM into the RAM 116 to be a temporary DGC management table 116DM, in order to manage GC operations according to the temporary DGC management table 116DM. The memory controller 110 may generate or update GC-management-related information in the DGC management table 116DM, and update the DGC management table 120DM according to the latest GC-management-related information in the DGC management table 116DM.

In addition, the aforementioned at least one NV memory element (e.g., the one or more NV memory elements such as {122-1, 122-2, . . . , 122-N_{E}}) may comprise a plurality of blocks {BLK}, where the minimum unit that the memory controller 110 may perform operations of erasing data on the NV memory 120 may be a block, and the minimum unit that the memory controller 110 may perform operations of writing data on the NV memory 120 may be a page, but the present invention is not limited thereto. For example, any NV memory element 122-n (where “n” may represent any integer in the interval [1, N_{E}]) within the NV memory elements 122-1, 122-2, . . . and 122-N_{E}, may comprise multiple blocks, and a block within the multiple blocks may comprise and record a specific number of pages, where the memory controller 110 may access a certain page of a certain block within the multiple blocks according to a block address and a page address.

According to some embodiments, the memory controller 110 may calculate the number of pages with valid data in any block BLK among the plurality of blocks {BLK} to be the valid page count VPC of the above-mentioned any blocks BLK, and select blocks {BLK} with smaller valid page counts {VPC} as GC source blocks for performing at least one GC operation, in order to maximize the number of blocks {BLK} released by the aforementioned at least one GC operation, but the invention is not limited thereto. According to some embodiments, the memory controller 110 may perform per-NV-memory-element GC operations such as per-die/per-chip GC operations to enhance overall performance, and more particularly, divide at least one portion of blocks {BLK} among the plurality of blocks {BLK} of the NV memory 120 into blocks respectively corresponding to multiple channels {CH} (e.g., the channels {CH(c)|c=1, 2, . . . , c_{MAX}}), and when performing GC operations, use first blocks {BLK} corresponding to a first channel CH(c=c1) together as first source blocks {BLK_{SOURCE}} of a first GC operation and determine a first target block BLK corresponding to the first channel CH(c=c1) to be a first destination block BLK_{DESTINATION} of the first GC operation, and use second blocks {BLK} corresponding to a second channel CH(c=c2) together as second source blocks {BLK_{SOURCE}} of a second GC operation and determine a second target block BLK corresponding to the second channel CH(c=c2) to be a second destination block BLK_{DESTINATION} of the second GC operation, to make the GC operations proceed according to the multiple channels {CH}, respectively, in order to enhance overall GC performance.

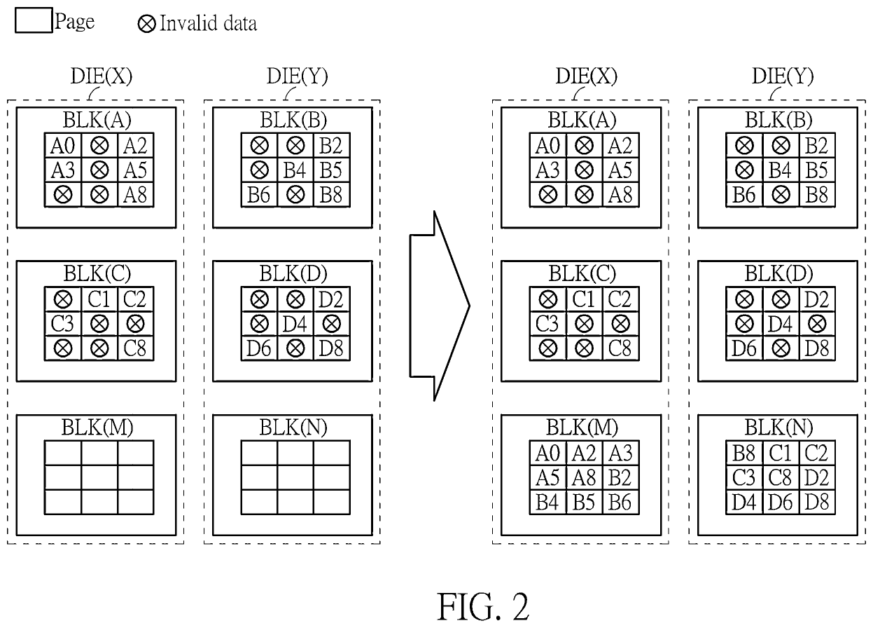

FIG. 2 illustrates a NV-memory-element-unaware block selection control scheme. For better comprehension, when there is a need, the memory controller 110 may operate according to the NV-memory-element-unaware block selection control scheme, but the invention is not limited thereto. For example, the memory controller 110 may operate according to at least one other control scheme. In addition, the plurality of NV memory elements 122-1, 122-2, . . . , and 122-N_{E} may be implemented by the plurality of flash memory dies {DIE} (e.g., the dies DIE(X) and DIE(Y)), but the present invention is not limited thereto. According to some embodiments, the plurality of NV memory elements 122-1, 122-2, . . . , and 122-N_{E} may be implemented by the plurality of flash memory chips {CHIP}, where the dies DIE(X) and DIE(Y) shown in FIG. 2 may be replaced by the chips CHIP(X) and CHIP(Y), respectively.

For example, the blocks BLK(A), BLK(B), BLK(C) and BLK(D) may store data such as valid data (e.g., the data A0, A2, A3, A5, A8, B2, B4, B5, B6, B8, C1, C2, C3, C8, D2, D4, D6 and D8) and invalid data (labeled “⊗” for brevity), while the blocks BLK(M) and BLK(N) may be blocks that have not stored any data after being erased. As shown in the left half part of FIG. 2, the blocks BLK(A), BLK(C) and BLK(M) may belong to a certain NV memory element such as the die DIE(X), and the blocks BLK(B), BLK(D) and BLK(N) may belong to another NV memory element such as the die DIE(Y). Multiple pages of the block BLK(A) may comprise five valid pages that store valid data (e.g., the data A0, A2, A3, A5 and A8), multiple pages of the block BLK(B) may comprise five valid pages that store valid data (e.g., the data B2, B4, B5, B6 and B8) respectively, multiple pages of the block BLK(C) may comprise four valid pages that store valid data (e.g., the data C1, C2, C3 and C8) respectively, and multiple pages of the block BLK(D) may comprise four valid pages that store valid data (e.g., the data D2, D4, D6 and D8) respectively. As shown in the right half part of FIG. 2, during performing GC, the memory controller 110 may first sequentially write the data A0, A2, A3, A5 and A8 in the valid pages of the block BLK(A) into the block BLK(M), and then sequentially write the data B2, B4, B5, B6 and B8 in the valid pages of the block BLK(B) into the blocks BLK(M) and BLK(N), and afterward, write the data C1, C2, C3 and C8 in the valid pages of the block BLK(C) and the data D2, D4, D6 and D8 in the valid pages of the block BLK(D) into the block BLK(N).

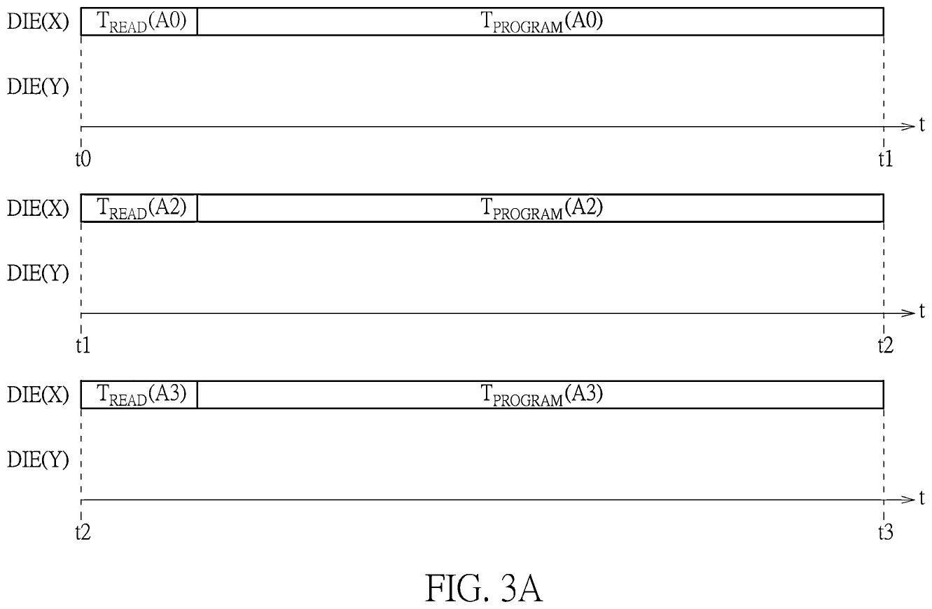

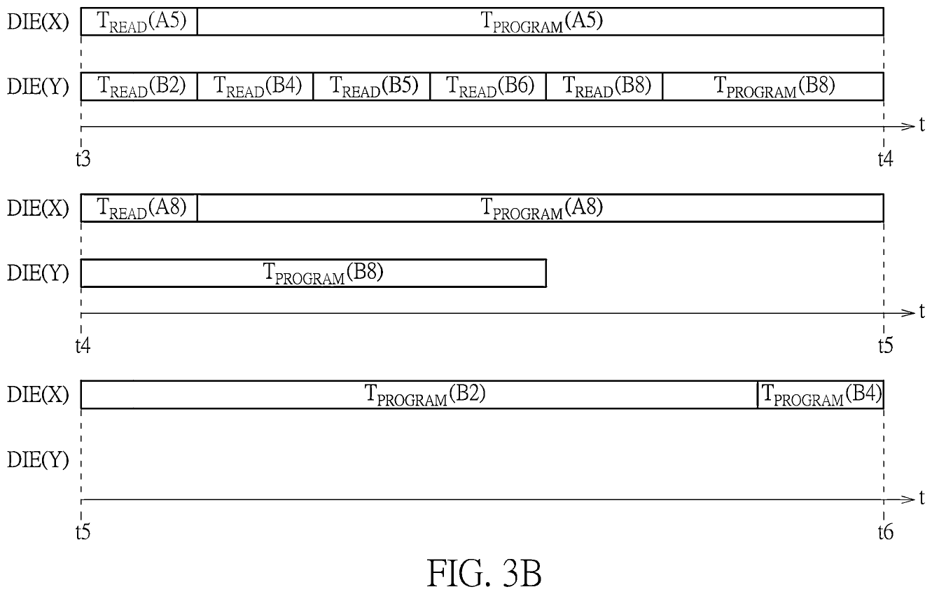

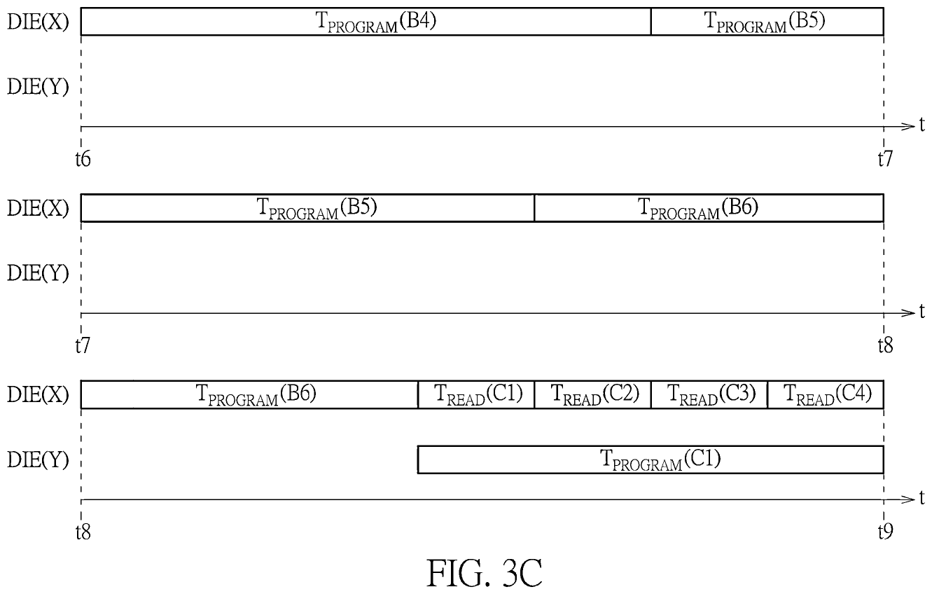

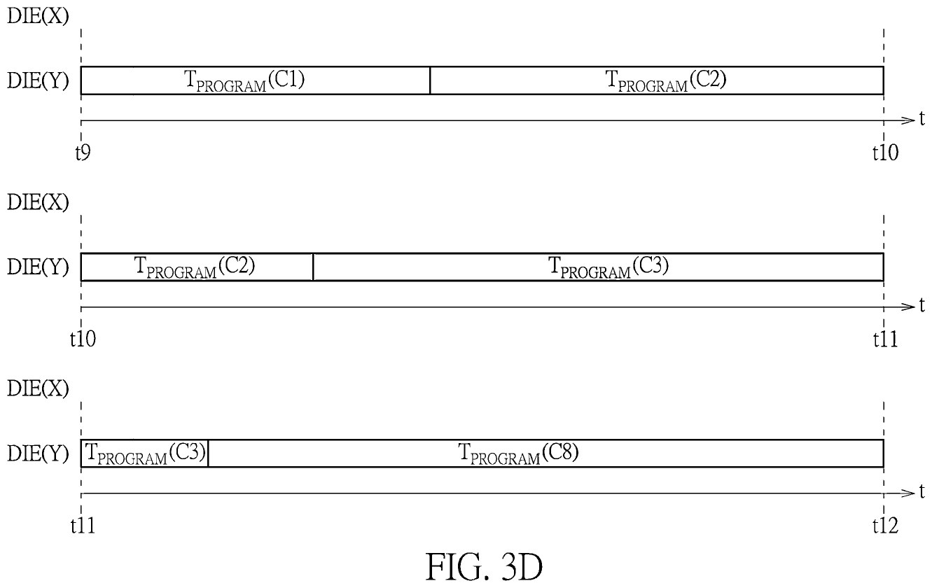

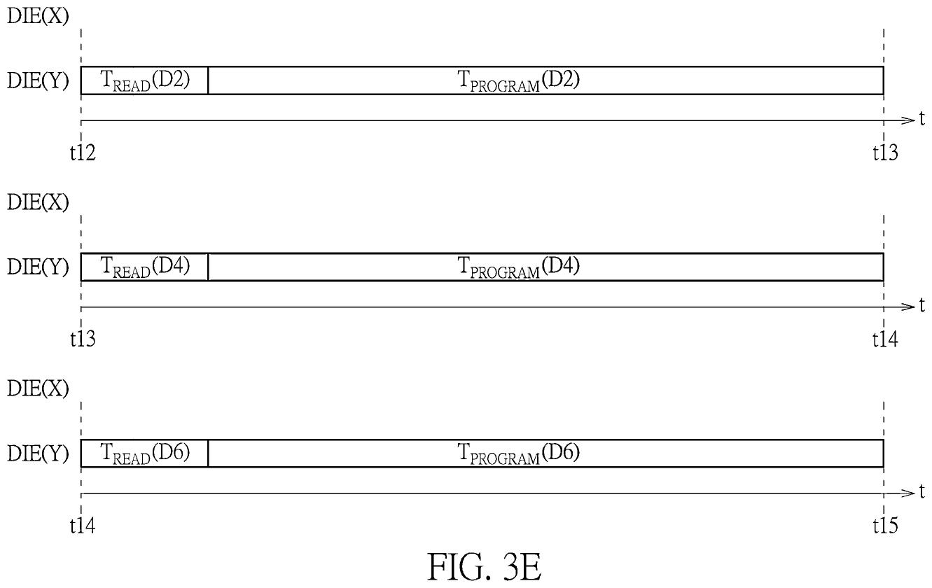

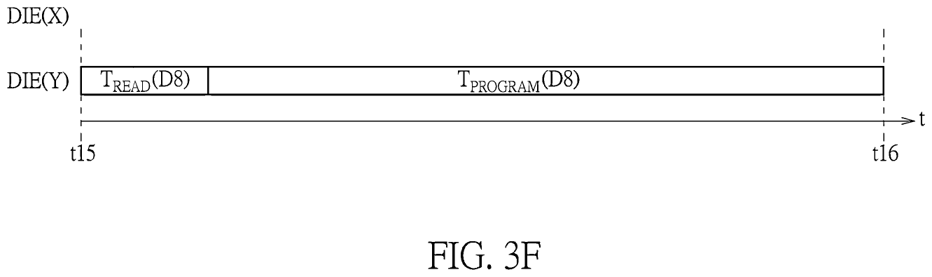

FIG. 3A to FIG. 3F illustrate multiple parts of a timing diagram of the NV-memory-element-unaware block selection control scheme shown in FIG. 2, respectively, where any two adjacent intervals among the intervals [t0, t1], [t1, t2], . . . and [t15, t16] between a series of time points {t0, t1, . . . , t16} may be equal to each other. The first part shown in FIG. 3A may comprise the respective partial timing sequences of the intervals [t0, t1], [t1, t2] and [t2, t3], the second part shown in FIG. 3B may comprise the respective partial timing sequences of the intervals [t3, t4], [t4, t5] and [t5, t6], the third part shown in FIG. 3C may comprise the respective partial timing sequences of the intervals [t6, t7], [t7, t8] and [t8, 19], the fourth part shown in the FIG. 3D may comprise the respective partial timing sequences of the intervals [t9, t10], [t10, t11] and [t11, t12], the fifth part shown in FIG. 3E may comprise the respective partial timing sequences of the intervals [t12, t13], [t13, t14] and [t14, t15], and the sixth part shown in FIG. 3F may comprise the partial timing sequence of the interval [t15, t16].

In addition, any data among the above-mentioned valid data (e.g., the data A0, A2, A3, A5, A8, B2, B4, B5, B6, B8, C1, C2, C3, C8, D2, D4, D6 and D8) may be labeled next to a busy time (e.g., the program busy time T_{PROGRAM} or the read busy time T_{READ}), for indicating the busy time corresponding to the above-mentioned any data. The busy time may represent the busy time of the above-mentioned any NV memory element 122-n operating in response to an operation command that is received. For example, the read busy time T_{READ} may represent the busy time of the above-mentioned any NV memory element 122-n (e.g., the die DIE(X) or the die DIE(Y)) operating in response to a first operation command that is received, such as a read operation command, and the program busy time T_{PROGRAM} may represent the busy time of the above-mentioned any NV memory element 122-n (e.g., the die DIE(X) or the die DIE(Y)) operating in response to a second operation command that is received, such as a program operation command, but the present invention is not limited thereto. According to some embodiments, the dies DIE(X) and DIE(Y) shown in FIGS. 3A to FIGS. 3F may be replaced by the chips CHIP(X) and CHIP(Y), respectively.

The program busy time T_{PROGRAM} of a program operation of the NV memory 120 (or the above-mentioned any NV memory element 122-n therein) may be significantly greater than the read busy time T_{READ} of a read operation of the NV memory 120 (or the above-mentioned any NV memory element 122-n therein). For better comprehension, assume that the program busy time T_{PROGRAM} may be six times the read busy time T_{READ}, but the invention is not limited to this. As shown in FIG. 3A to FIG. 3F, the total time such as the length of the interval [t0, t16] may be equal to 112 times the read busy time T_{READ}. During performing GC, one of any two NV memory elements {122-n} (e.g. the die DIE(X) and the die DIE(Y)) may be in an idle state for some periods of time, which may cause the overall performance to be reduced, where the overall performance may become lower when the total number of the plurality of NV memory elements 122-1, 122-2, . . . , and 122-N_{E} is increased for configuring larger storage capacity. The memory controller 110 may operate according to at least one other control scheme, and more particularly, perform per-NV-memory-element block selection operations such as per-die/per-chip block selection operations regarding GC, to enhance the overall performance.

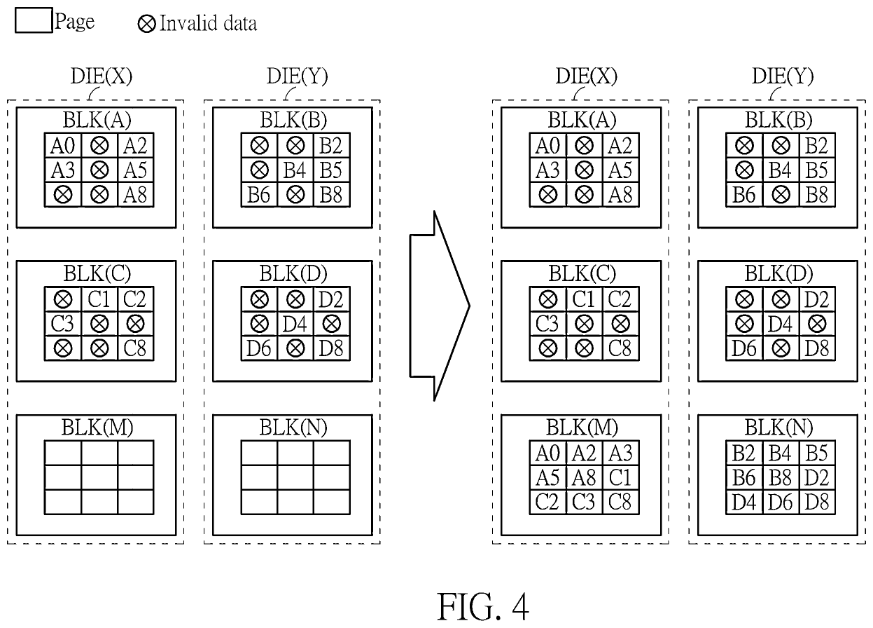

FIG. 4 illustrates a NV-memory-element-aware block selection control scheme of a method for performing GC management of a memory device with aid of dedicated information control according to an embodiment of the present invention. The memory controller 110 may operate according to at least one control scheme of the method (e.g., the NV-memory-element-aware block selection control scheme). For better comprehension, the plurality of NV memory elements 122-1, 122-2, . . . , and 122-N_{E} may be implemented by the plurality of flash memory dies {DIE} (e.g., the dies DIE(X) and DIE(Y)), but the present invention is not limited thereto. According to some embodiments, the plurality of NV memory elements 122-1, 122-2, . . . , and 122-N_{E} may be implemented by the plurality of flash memory chips {CHIP}, where the dies DIE(X) and DIE(Y) as shown in FIG. 4 may be replaced by the chips CHIP(X) and CHIP(Y), respectively.

During performing GC, the memory controller 110 may control the above-mentioned any two NV memory elements {122-n} (e.g., the die DIE(X) and the die DIE(Y)) to perform parallel operations, and more particularly, perform the respective GC operations of one (e.g., the die DIE(X)) of the above-mentioned any two NV memory elements {122-n} and the other one (e.g., the die (Y)) of the above-mentioned any two NV memory elements {122-n} at the same time. As shown in the left half part of FIG. 4, the blocks BLK(A), BLK(B), BLK(C) and BLK(D) may store data such as the above-mentioned valid data (e.g., the data A0, A2, A3, A5, A8, B2, B4, B5, B6, B8, C1, C2, C3, C8, D2, D4, D6 and D8) and the above-mentioned invalid data (labeled “⊗” for brevity), while the blocks BLK(M) and BLK(N) may be blocks that have not stored any data after being erased. As shown in the right half part of FIG. 4, the parallel operations mentioned above may comprise:
(1) regarding the die DIE(X), the memory controller 110 may first sequentially write the data A0, A2, A3, A5 and A8 in the valid pages of the block BLK(A) into the block BLK(M), and then sequentially write the data C1, C2, C3 and C8 in the valid pages of the block BLK(C) into the block BLK(M); and
(2) regarding the die DIE(Y), the memory controller 110 may first sequentially write the data B2, B4, B5, B6 and B8 in the valid pages of the block BLK(B) into the block BLK(N), and then sequentially write the data D2, D4, D6 and D8 in the valid pages of the block BLK(D) into block BLK(N);
   but the present invention is not limited thereto. According to some embodiments, the memory controller 110 may first perform a first set of parallel operations among the parallel operations mentioned above, and then perform a second set of parallel operations among the parallel operations mentioned above. For example, the first set of parallel operations may comprise:
(1) regarding the die DIE(X), the memory controller 110 may sequentially write the data A0, A2, A3, A5 and A8 in the valid pages of the block BLK(A) into the block BLK(M); and
(2) regarding the die DIE(Y), the memory controller 110 may sequentially write the data B2, B4, B5, B6 and B8 in the valid pages of the block BLK(B) into the block BLK(N).
   Additionally, the second set of parallel operations may comprise:
(1) regarding the die DIE(X), the memory controller 110 may sequentially write the data C1, C2, C3 and C8 in the valid pages of the block BLK(C) into the block BLK(M); and
(2) regarding the die DIE(Y), the memory controller 110 may sequentially write the data D2, D4, D6 and D8 in the valid pages of the block BLK(D) into the block BLK(N).

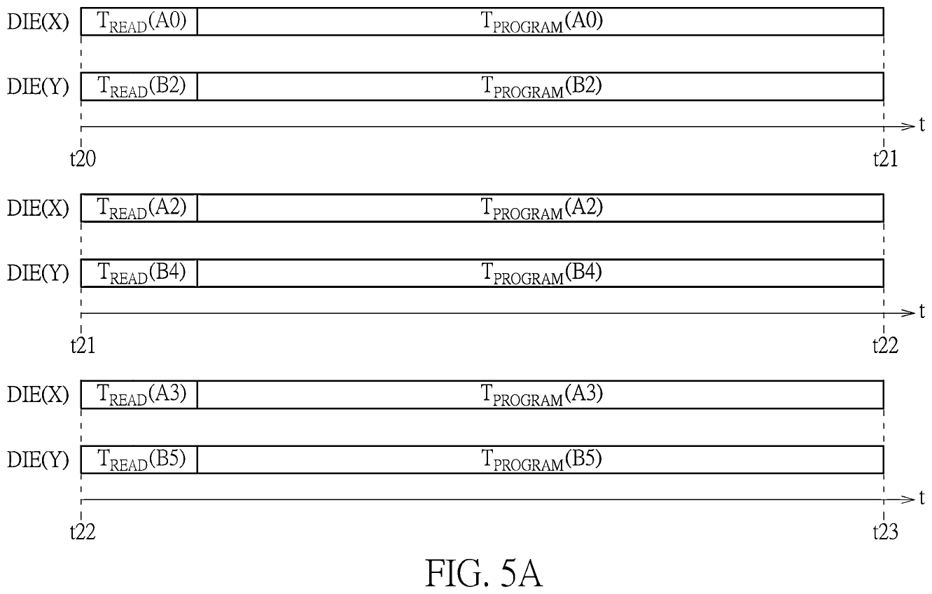

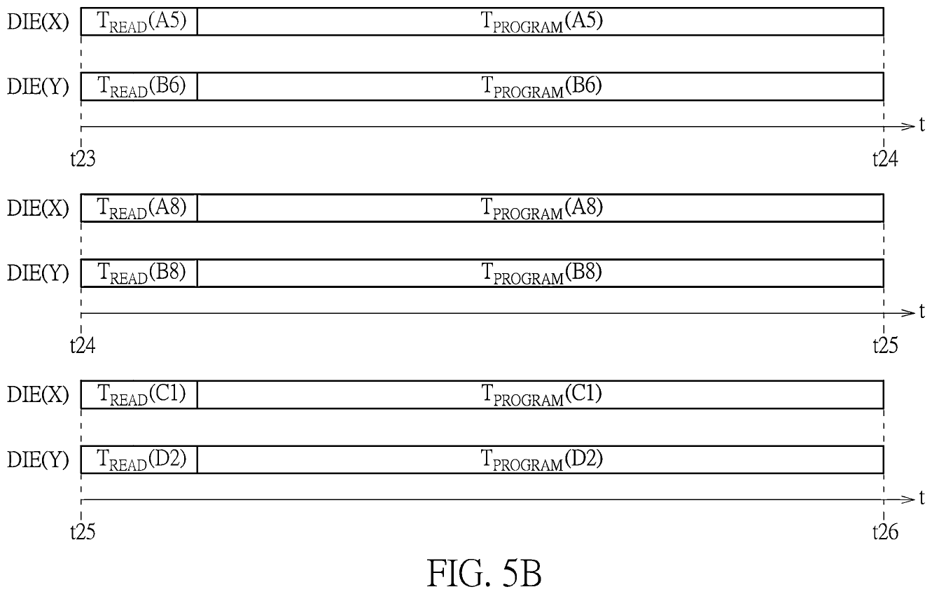

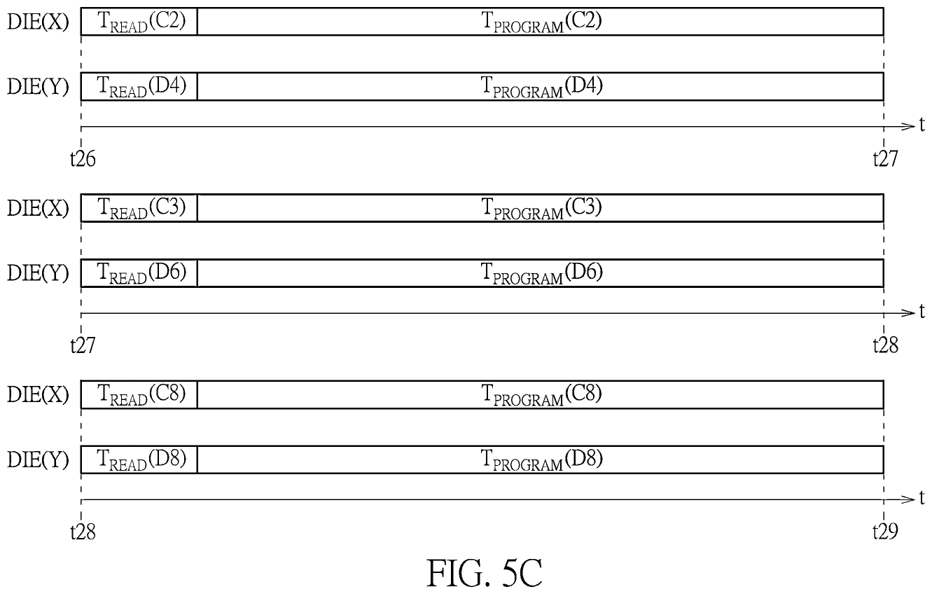

FIG. 5A, FIG. 5B and FIG. 5C illustrate a first part, a second part and a third part of a timing diagram of the NV-memory-element-aware block selection control scheme shown in FIG. 4, respectively, where any two adjacent intervals among the intervals [t20, t21], [t21, t22], . . . and [t28, t29] between a series of time points {t20, t21, . . . , t29} may be equal to each other. The first part shown in FIG. 5A may comprise the respective partial timing sequences of the intervals [t20, t21], [t21, t22] and [t22, t23], the second part shown in FIG. 5B may comprise the respective partial timing sequences of the intervals [t23, t24], [t24, t25] and [t25, t26], and the third part shown in FIG. 3C may comprise the respective partial timing sequences of the intervals [t26, t27],[t27, t28] and [t28, t29]. In addition, the read busy time T_{READ} may represent the busy time of the above-mentioned any NV memory element 122-n (e.g., the die DIE(X) or the die DIE(Y)) operating in response to the first operation command that is received, such as the read operation command, and the program busy time T_{PROGRAM} may represent the busy time of the above-mentioned any NV memory element 122-n (e.g., the die DIE(X) or the die DIE(Y)) operating in response to the second operation command that is received, such as the program operation command, but the invention is not limited thereto. According to some embodiments, the dies DIE(X) and DIE(Y) shown in FIGS. 5A to FIGS. 5C may be replaced by the chips CHIP(X) and CHIP(Y), respectively.

For better comprehension, any data among the above-mentioned valid data (e.g., the data A0, A2, A3, A5, A8, B2, B4, B5, B6, B8, C1, C2, C3, C8, D2, D4, D6 and D8) may be labeled next to a busy time (e.g., the program busy time T_{PROGRAM} or the read busy time T_{READ}), for indicating the busy time corresponding to the above-mentioned any data, where it may be assumed that the program busy time T_{PROGRAM} is six times the read busy time T_{READ}, but the present invention is not limited thereto. As shown in FIG. 5A to FIG. 5C, the total time such as the length of the interval [t20, t29] may be equal to 63 times the read busy time T_{READ}. Assume that “T1” represents the length of the interval [t0, t16], and “T2” represents the length of the interval [t20,t29]. As T1=(112*T_{READ}) and T2=(63*T_{READ}), the ratio R(T1, T2) of T1 to T2 may be calculated as follows:

R(T1,T2)=(T1/T2)=((112*T_{READ})/(63*T_{READ}))=(112/63)˜=1.778.

In comparison with the NV-memory-element-unaware block selection control scheme shown in FIG. 2, the NV-memory-element-aware block selection control scheme shown in FIG. 4 can significantly enhance the GC performance of the memory device 100, and therefore enhance the overall performance of the electronic device 10.

According to some embodiments, the dies DIE(X) and DIE(Y) may be respectively configured in different channels among the multiple channels {CH}, but the invention is not limited thereto. According to some embodiments, it is unnecessary to configure the dies DIE(X) and DIE(Y) in different channels of the multiple channels {CH}.

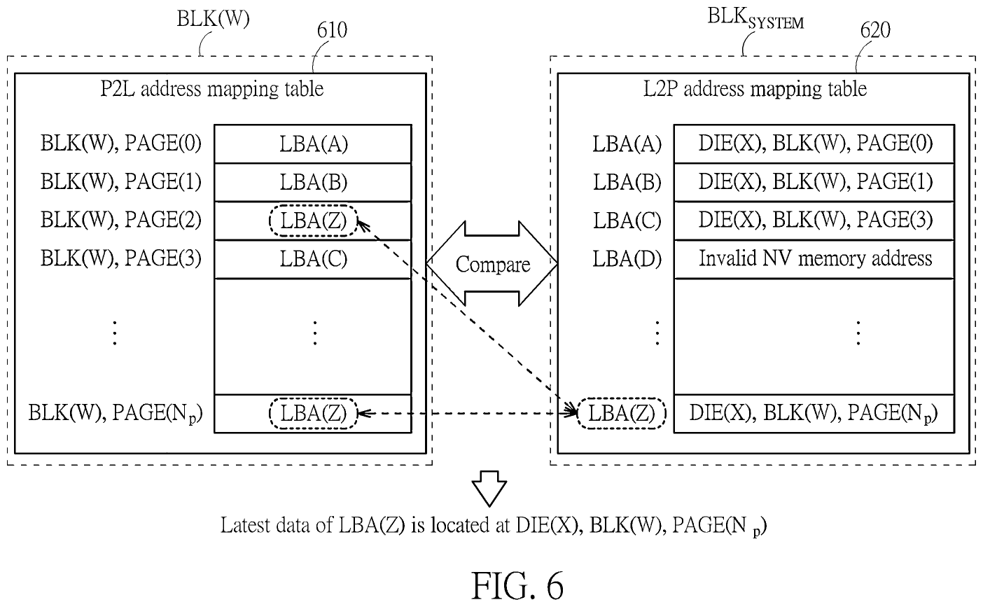

FIG. 6 illustrates a comparison control scheme of the method according to an embodiment of the present invention. After erasing the above-mentioned any block BLK among the plurality of blocks {BLK}, the memory controller 110 may start writing (or programming) host data from the host device 50 into the above-mentioned any block BLK. For example, the above-mentioned any block BLK may be a block BLK(W), and the memory controller 110 may write (or program) a set of partial data of the host data into a set of pages in the block BLK(W) to be valid data stored in the set of pages, and write a set of physical-to-logical (P2L) address mapping information of the set of partial data into at least one P2L address mapping table in the block BLK(W), for indicating a set of P2L mapping relationships from a set of physical addresses of the set of pages of the block BLK(W) to a set of logical addresses of the set of partial data, where the above-mentioned at least one P2L address mapping table may be collectively referred to as the P2L address mapping table 610. In addition, the set of P2L address mapping information may comprise a set of P2L address mapping table entries such as the set of logical addresses, and the arrangement order of the set of P2L address mapping table entries in the P2L address mapping table 610 may represent the set of physical addresses, but the present invention is not limited thereto. For example, the set of P2L address mapping information may comprise a combination of the set of physical addresses and the set of logical addresses.

As shown in the left half part of FIG. 6, after writing (or programming) at least one portion of the host data into the block BLK(W), the memory controller 110 may have recorded the set of logical addresses such as the logical block addresses (LBAs) {LBA(A), LBA(B), LBA(Z), LBA(C), . . . , LBA(Z)} to be the set of P2L address mapping table entries in the P2L address mapping table 610, and the ranking of the set of P2L address mapping table entries in the P2L address mapping table 610 may represent the set of physical addresses, such as the addresses of the pages {PAGE(0), PAGE(1), PAGE(2), PAGE(3), . . . , PAGE(N_{P})} of the block BLK(W) (labeled as a combination of “BLK(W)” and “{PAGE(0), PAGE(1), PAGE(2), PAGE(3), . . . , PAGE(N_{P})}” for brevity). The P2L address mapping table 610 may be arranged to indicate which LBA(s) the valid data among the host data written into the NV memory 120 is located at. For example, the memory controller 110 may store internal information (or non-host data) such as the plurality of local L2P address mapping tables into a system block BLK_{SYSTEM} in the predetermined region such as in the system region, and may refer to the set of P2L address mapping table entries (e.g., the set of logical addresses such as the LBAs {LBA(A), LBA(B), LBA(Z), LBA(C), . . . , LBA(Z)}) in the P2L address mapping table 610 to select at least one corresponding local L2P address mapping table from the plurality of local L2P address mapping tables, for performing address comparison, where the aforementioned at least one corresponding local L2P address mapping table may be collectively referred to as the L2P address mapping table 620. The L2P address mapping table 620 may comprise L2P address mapping information such as a set of L2P address mapping table entries, for indicating a set of L2P mapping relationships from a series of logical addresses (e.g., a series of LBAs such as the LBAs {LBA(A), LBA(B), LBA(C), LBA(D), . . . , LBA(Z)}) to associated physical addresses (e.g., the locations of the valid data among the host data in the NV memory 120). Assuming that there is no repeated P2L address mapping table entry in the set of P2L address mapping table entries (e.g., the set of logical addresses), the set of P2L mapping relationships indicated by the P2L address mapping table 610 and the set of L2P mapping relationships indicated by the L2P address mapping table 620 may be inverse mapping relationships of each other, but the present invention is not limited thereto.

As shown in the right half part of FIG. 6, in the L2P address mapping table 620, the set of L2P address mapping information such as the set of L2P address mapping table entries may be the above-mentioned associated physical addresses (e.g., the locations of the valid data among the host data in the NV memory 120), such as the addresses of the pages {PAGE(0), PAGE(1), PAGE(2), PAGE(3), . . . , PAGE(N_{P})} of the block BLK(W) of the die DIE(X) (labeled as a combination of “DIE(X)”, “BLK(W)” and “{PAGE(0), PAGE(1), PAGE(2), PAGE(3), . . . , PAGE(N_{P})}” for brevity), but the present invention is not limited thereto. For example, the set of L2P address mapping information may comprise a combination of the series of logical addresses and the above-mentioned associated physical addresses. In addition, the memory controller 110 may refer to the P2L address mapping table 610 and the L2P address mapping table 620 to determine which LBAs the valid data among the host data written into the NV memory 120 is located at. For example, during performing GC, the memory controller 110 may read the P2L address mapping table 610 of the block BLK(W) from the block BLK(W), and read the latest L2P address mapping information in the system block BLK_{SYSTEM}, such as the set of L2P address mapping information in the L2P address mapping table 620, to sequentially compare the set of P2L address mapping table entries (e.g., the set of logical addresses such as the LBAs {LBA(A), LBA(B), LBA(Z), LBA(C), . . . , LBA(Z)}) in the P2L address mapping table 610 and corresponding L2P address mapping table entries in the P2L address mapping table 610, in order to obtain the locations of the valid data of the block BLK(W).

The memory controller 110 may update any local L2P address mapping table in the global L2P address mapping table 120AM, such as the L2P address mapping table 620, to maintain the set of L2P address mapping information therein as the latest L2P address mapping information. When the set of L2P address mapping information in the L2P address mapping table 620 is the latest L2P address mapping information, the memory controller 110 may performing the determination related to whether the stored data is valid or invalid based on the L2P address mapping table 620. In addition, the set of L2P address mapping information may be implemented as per-NV-memory-element mapping information such as per-die/per-chip mapping information, to integrate the die/chip information indicating the die/chip (e.g., the die DIE(X) or the chip CHIP(X)) to which the block BLK(W) belongs into the set of L2P address mapping table entries (e.g., the above-mentioned associated physical addresses), to allow the memory controller 110 to refer to the L2P address mapping table 620 to determine which block BLK (e.g., the block BLK(W)) the valid data is located in and determine which die/chip (e.g., the die DIE(X) or the chip CHIP(X)) this block BLK (e.g., block BLK(W)) belongs to. For example, during performing GC, the memory controller 110 may determine that the latest data of the LBA LBA(Z) is located at the page PAGE(N_{P}) of the block BLK(W) of the die DIE(X), but the invention is not limited thereto. According to some embodiments, the plurality of NV memory elements 122-1, 122-2, . . . , and 122-N_{E} may be implemented by the plurality of flash memory chips {CHIP}, and among the set of L2P address mapping table entries in the L2P address mapping table 620 shown in FIG. 6, the local L2P address mapping table information for indicating the die DIE(X) (labeled “DIE(X)” for brevity) may be replaced by the local L2P address mapping table information for indicating the chip CHIP(X) (which may be labeled “CHIP(X)” for brevity). During performing GC, the memory controller 110 may determine that the latest data of the LBALBA(Z) is located at the page PAGE(N_{P}) of the block BLK(W) of the chip CHIP(X).

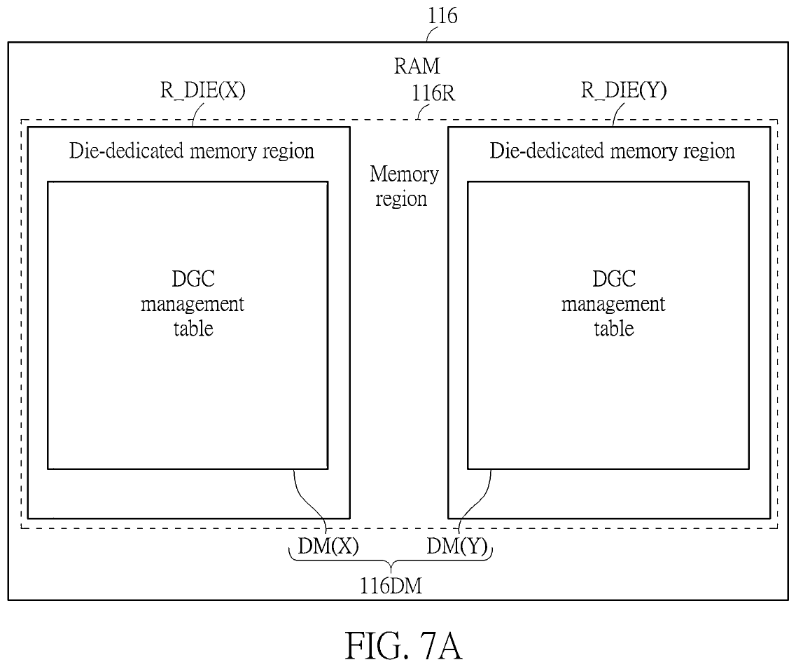

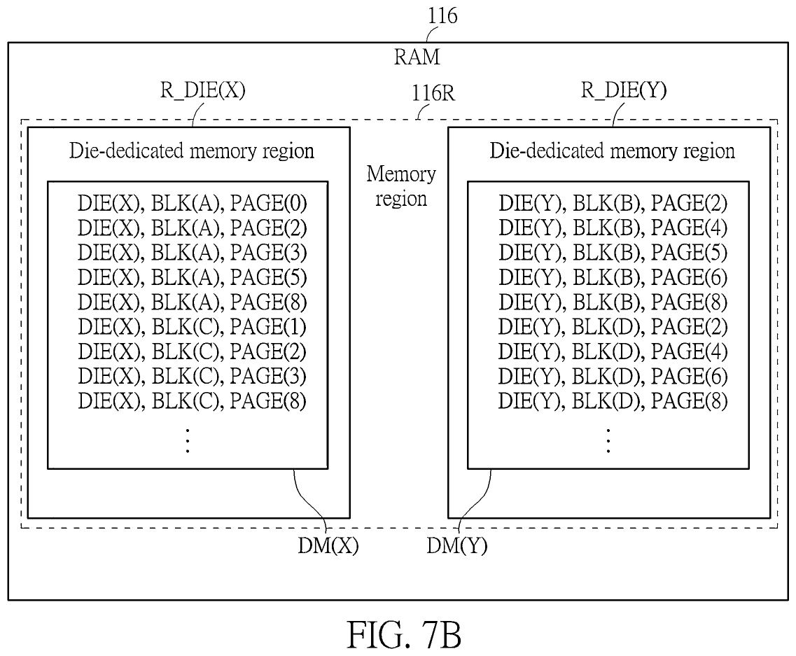

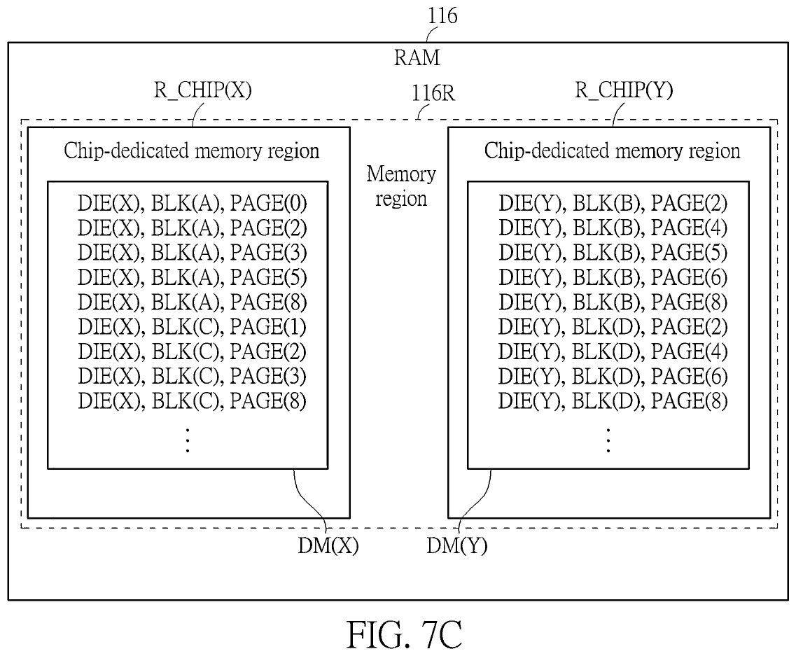

FIG. 7A illustrates a NV-memory-element-dedicated memory region control scheme of the method according to an embodiment of the present invention. Assuming that the plurality of NV memory elements 122-1, 122-2, . . . , and 122-N_{E} are implemented by the plurality of flash memory dies {DIE} for better comprehension, the memory controller 110 may divide a memory region 116R for storing the temporary DGC management table 116DM in the RAM 116 into N_{E} sub-regions according to the number N_{E} of the plurality of the NV memory elements 122-1, 122-2, . . . , and 122-N_{E} (e.g. the dies DIE(1), DIE(2), . . . , and DIE(N_{E})) to be the N_{E} die-dedicated memory regions {R_DIE} (e.g., the die-dedicated memory regions {R_DIE(1), R_DIE(2), . . . , R_DIE(N_{E})}) respectively corresponding to the dies DIE(1), DIE(2), . . . , and DIE(N_{E}), and store the N_{E} DGC management tables {DM} (e.g., the DGC management tables {DM(1), DM(2)), . . . , DM(N_{E})}) corresponding to the dies DIE(1), DIE(2), . . . , and DIE(N_{E}) in the N_{E} die-dedicated memory regions {R_DIE}, respectively, where the N_{E} sub-regions may be regarded as N_{E} per-die dedicated sub-region, but the present invention is not limited thereto. For example, the plurality of NV memory elements 122-1, 122-2, . . . , and 122-N_{E} may be implemented by the plurality of flash memory chips {CHIP}, and the N_{E} die-dedicated memory regions {R_DIE} may be replaced by N_{E} chip-dedicated memory regions {R_CHIP} (e.g., the chip-dedicated memory regions {R_CHIP(1), R_CHIP(2), . . . , R_CHIP (N_{E})}), for storing the N_{E} DGC management tables {DM}. In this situation, the N_{E} sub-regions may be regarded as N_{E} per-chip dedicated sub-region.

As shown in FIG. 7A, the N_{E} die-dedicated memory regions {R_DIE} may comprise the die-dedicated memory regions R_DIE(X) and R_DIE(Y) respectively corresponding to the dies DIE(X) and DIE(Y), for storing the DGC management tables DM(X) and DM(Y) corresponding to the dies DIE(X) and DIE(Y), respectively, where the above-mentioned temporary DGC management table 116DM may comprise the DGC management tables DM(X) and DM(Y), but the present invention is not limited thereto. According to some embodiments, more sub-regions such as more die-dedicated memory regions {R_DIE} and more DGC management tables {DM} therein may be illustrated in the memory region 116R.

FIG. 7B illustrates some implementation details of the NV-memory-element-dedicated memory region control scheme shown in FIG. 7A. The memory controller 110 may operate according to the aforementioned at least one control scheme (e.g., the NV-memory-element-aware block selection control scheme, the comparison control scheme and the NV-memory-element-dedicated memory region control scheme) of the method, and more particularly, update the above-mentioned at least one DGC management table (e.g., the DGC management table 116DM and/or the DGC management table 120DM) for performing the associated operations. The memory controller 110 may compare the P2L address mapping table 610 and the L2P address mapping table 620 to determine the location information of the valid data among the host data written to the NV memory 120, and record the location information, for indicating the location(s) of the valid data, for example, indicating which pages {PAGE} of which block BLK (e.g., the block BLK(W)) the valid data is located in and which die (e.g., the die DIE(X)) this block BLK (e.g., the block BLK(W)) belongs to.

For example, during performing GC, the memory controller 110 may update at least one portion of DGC management tables {DM} among the N_{E} DGC management tables {DM}, such as the DGC management tables DM(X) and DM(Y). As shown in the left half part of FIG. 7B, the location information recorded in the DGC management table DM(X) by the memory controller 110 may comprise the addresses of the pages {PAGE(0), PAGE(2), PAGE(3), PAGE(5), PAGE(8)} of the block BLK(A) of the die DIE(X) (labeled as a combination of “DIE(X)”, “BLK(A)” and “{PAGE(0), PAGE(2), PAGE(3), PAGE(5), PAGE(8)}” for brevity), and comprise the addresses of the pages {PAGE(1), PAGE(2), PAGE(3), PAGE(8)} of the block BLK(C) of the die DIE(X) (labeled as a combination of “DIE(X)”, “BLK(C)” and “{PAGE(1), PAGE(2), PAGE(3), PAGE(8)}” for brevity). As shown in the right half part of FIG. 7B, the location information recorded in the DGC management table DM(Y) by the memory controller 110 may comprise the addresses of the pages {PAGE(2), PAGE(4), PAGE(5), PAGE(6), PAGE(8)} of the block BLK(B) of the die DIE(Y) (labeled as a combination of “DIE(Y)”, “BLK(B)” and “{PAGE(2), PAGE(4), PAGE(5), PAGE(6), PAGE(8)}” for brevity), and comprise the addresses of the pages {PAGE(2), PAGE(4), PAGE(6), PAGE(8)} of the block BLK(D) of the die DIE(Y) (labeled as a combination of “DIE(Y)”, “BLK(D)” and “{PAGE(2), PAGE(4), PAGE(6), PAGE(8)}” for brevity).

FIG. 7C illustrates some other implementation details of the NV-memory-element-dedicated memory region control scheme shown in FIG. 7A, where the die-dedicated memory regions R_DIE(X) and R_DIE(Y) respectively corresponding to the dies DIE(X) and DIE(Y) as shown in FIG. 7B may be replaced by the chip-dedicated memory regions R_CHIP(X) and R_CHIP(Y) respectively corresponding to the chips CHIP(X) and CHIP(Y) as shown in FIG. 7C, but the present invention is not limited thereto. According to some embodiments, more sub-regions such as more chip-dedicated memory regions {R_CHIP} and more DGC management tables {DM} therein may be illustrated in the memory region 116R.

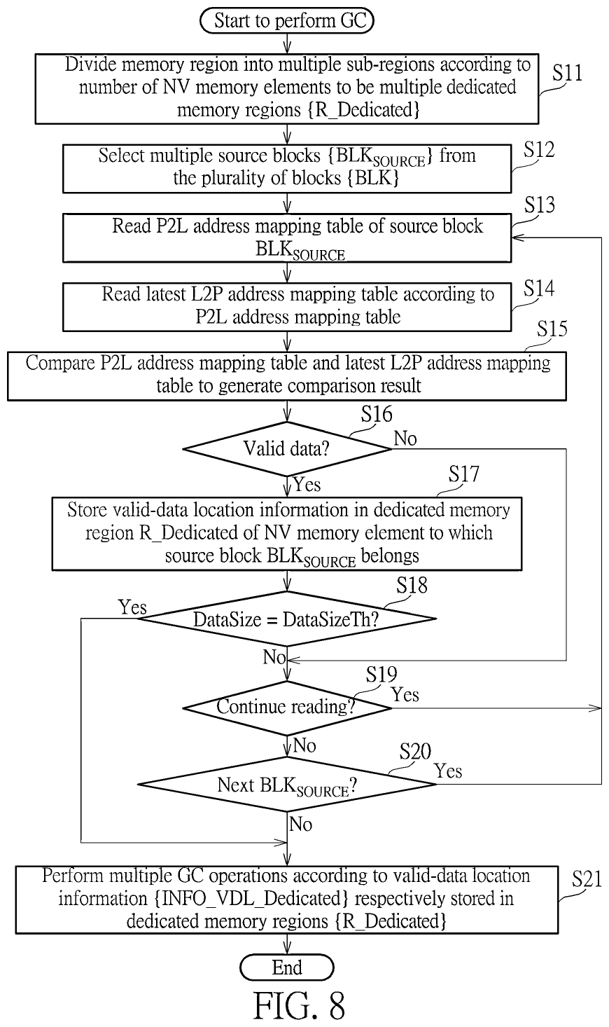

FIG. 8 illustrates a working flow of the method according to an embodiment of the present invention. The memory controller 110 may receive at least one first command (e.g., write command) among the plurality of host commands from the host device 50 through the transmission interface circuit 118 within the memory controller 110, and perform at least one accessing operation on the NV memory 120 according to the aforementioned at least one first command, where the at least one first command may indicate at least one write request from the host device 50, and the at least one accessing operation may represent at least one write operation. For example, the memory controller 110 may write (or program) the host data from the host device 50 into at least one block BLK among the plurality of blocks {BLK}, and update the global L2P address mapping table 120AM in the NV memory 120 correspondingly, for indicating the mapping relationships from logical addresses to physical addresses. In addition, the memory controller 110 may execute a GC procedure such as the working flow shown in FIG. 8 to start performing GC on the NV memory 120. As the memory controller 110 has updated the global L2P address mapping table 120AM before executing the GC procedure, the plurality of local L2P address mapping tables within the global L2P address mapping table 120AM may be regarded as the latest local L2P address mapping tables.

In Step S11, the memory controller 110 may divide the memory region 116R for storing the temporary DGC management table 116DM in the RAM 116 within the memory controller 110 into the N_{E} sub-regions according to the number N_{E} of the aforementioned at least one NV memory element (e.g., the plurality of the NV memory elements 122-1, 122-2, . . . , and 122-N_{E}, such as dies DIE(1), DIE(2), . . . , and DIE(N_{E}) or the chips CHIP(1), CHIP(2), . . . , and CHIP(N_{E})) to be N_{E} dedicated memory regions {R_Dedicated}, where the number N_{E} of the above-mentioned at least one NV memory element may be greater than one. More particularly, the above-mentioned at least one NV memory element may comprise the plurality of NV memory elements 122-1, 122-2, . . . , and 122-N_{E}, and the N_{E} dedicated memory regions {R_Dedicated} may represent N_{E} NV-memory-element-dedicated memory regions corresponding to the plurality of NV memory elements 122-1, 122-2, . . . , and 122-N_{E}, such as the dedicated memory regions {R_Dedicated(1), R_Dedicated(2), . . . , R_Dedicated(N_{E})} corresponding to the NV memory elements {122-1, 122-2, . . . , 122-N_{E}}, for storing the N_{E} DGC management tables {DM} (e.g., the DGC management tables {DM(1), DM(2), . . . , DM(N_{E})}) corresponding to the NV memory elements {122-1, 122-2, . . . , 122-N_{E}}, respectively.

For example, the plurality of NV memory elements 122-1, 122-2, . . . , and 122-N_{E} may represent the plurality of flash memory dies {DIE} such as the dies DIE(1), DIE(2), . . . , and DIE(N_{E}), and the N_{E} dedicated memory regions {R_Dedicated} such as the dedicated memory regions {R_Dedicated(1), R_Dedicated(2), . . . , R_Dedicated(N_{E})} may represent the N_{E} die-dedicated memory regions {R_DIE} respectively corresponding to the plurality of flash memory dies {DIE}, such as the die-dedicated memory regions {R_DIE(1), R_DIE(2), . . . , R_DIE(N_{E})} (e.g., the die-dedicated memory regions R_DIE(X) and R_DIE(Y) shown in FIG. 7A) respectively corresponding to the dies {DIE(1), DIE(2), . . . , DIE(N_{E})}. In another example, the plurality of NV memory elements 122-1, 122-2, . . . , and 122-N_{E} may represent the plurality of flash memory chips {CHIP} such as the chips CHIP(1), CHIP(2), . . . , and CHIP(N_{E}), and the N_{E} dedicated memory regions {R_Dedicated} such as the dedicated memory regions {R_Dedicated(1), R_Dedicated(2), . . . , R_Dedicated(N_{E})} may represent the N_{E} chip-dedicated memory regions {R_CHIP} respectively corresponding to the plurality of flash memory chip {CHIP}, such as the chip-dedicated memory regions {R_CHIP(1), R_CHIP(2), . . . , R_CHIP(N_{E})} (e.g., the chip-dedicated memory regions R_CHIP(X) and R_CHIP(Y) shown in FIG. 7C) respectively corresponding to the chips CHIP(1), CHIP(2), . . . , and CHIP(N_{E}).

In Step S12, the memory controller 110 may select multiple source blocks {BLK_{SOURCE}} from the plurality of blocks {BLK}.

In Step S13, the memory controller 110 may read a P2L address mapping table (e.g., the P2L address mapping table 610 shown in FIG. 6) of any source block BLK_{SOURCE} among the multiple source blocks {BLK_{SOURCE}}.

In Step S14, the memory controller 110 may read a latest L2P address mapping table (e.g., the L2P address mapping table 620 shown in FIG. 6) according to the P2L address mapping table (e.g., the P2L address mapping table 610 shown in FIG. 6) of the above-mentioned any source block BLK_{SOURCE}, and more particularly, refer to any P2L address mapping table entry in the P2L address mapping table to read a corresponding L2P address mapping table entry in the latest L2P address mapping table, for determining whether the data corresponding to the P2L address mapping table entry in the above-mentioned any source block BLK_{SOURCE} is valid data.

For example, the latest L2P address mapping table may represent a local L2P address mapping table corresponding to the above-mentioned any source block BLK_{SOURCE} among the plurality of local L2P address mapping tables. According to a logical address indicated by the above-mentioned any P2L address mapping table entry in the P2L address mapping table, the memory controller 110 may select a local L2P address mapping table having the corresponding L2P address mapping table entry (e.g., an L2P address mapping table entry for mapping from the logical address to an associated physical address) from the plurality of local L2P address mapping tables to be the latest L2P address mapping table, where this local L2P address mapping table may have a predetermined mapping range, for mapping from a series of logical addresses comprising the logical address to associated physical addresses, respectively. As the memory controller 110 has updated the plurality of local L2P address mapping tables in the global L2P address mapping table 120AM before executing the GC procedure, all L2P address mapping table entries in the latest L2P address mapping table should all be correct. Therefore, if the above-mentioned any P2L address mapping table entry and the corresponding L2P address mapping table entry match each other (e.g., the P2L address mapping relationship indicated by this P2L address mapping table entry and the L2P address mapping relationship indicated by this L2P address mapping table entry are inverse mapping relationships of each other), then the data corresponding to the above-mentioned any P2L address mapping table entry in the above-mentioned any source block BLK_{SOURCE} is valid data; otherwise, the data corresponding to the above-mentioned any P2L address mapping table entry in the above-mentioned any source block BLK_{SOURCE} is invalid data.

As shown in FIG. 8, the memory controller 110 may execute at least one loop comprising at least one portion of steps among Steps S13 to S19, more particularly, execute Step S14 multiple times to read a set of L2P address mapping table entries in the latest L2P address mapping table according to a set of P2L address mapping table entries in the P2L address mapping table of the above-mentioned any source block BLK_{SOURCE}, for determining whether the data corresponding to the set of P2L address mapping table entries in the above-mentioned any source block BLK_{SOURCE} is valid data, where the P2L address mapping table entries in the P2L address mapping table 610 shown in FIG. 6 may be taken as examples of the set of P2L address mapping table entries, and the L2P address mapping table entries in the L2P address mapping table 620 shown in FIG. 6 may be taken as examples of the set of L2P address mapping table entries, but the present invention is not limited thereto. Assume that the above-mentioned any P2L address mapping table entry is one of the set of P2L address mapping table entries, and the corresponding L2P address mapping table entry is one of the set of L2P address mapping table entries. If the above-mentioned any P2L address mapping table entry and the corresponding L2P address mapping table entry match each other, then the data corresponding to the above-mentioned any P2L address mapping table entry in the above-mentioned any source block BLK_{SOURCE} is valid data; otherwise, the data corresponding to the above-mentioned any P2L address mapping table entry in the above-mentioned any source block BLK_{SOURCE} is invalid data. Similarly, if the set of P2L address mapping table entries and the set of L2P address mapping table entries match each other (e.g., the P2L address mapping relationships indicated by the set of P2L address mapping table entries and the L2P address mapping relationships indicated by the set of L2P address mapping table entries are inverse mapping relationships of each other), then all the data corresponding to the set of P2L address mapping table entries in the above-mentioned any source block BLK_{SOURCE} are valid data.

In Step S15, the memory controller 110 may compare the P2L address mapping table of the above-mentioned any source block BLK_{SOURCE} and the latest L2P address mapping table, and more particularly, compare the above-mentioned any P2L address mapping table entry and the corresponding L2P address mapping table entry to generate a comparison result, for indicating whether the data corresponding to the above-mentioned any P2L address mapping table entry in the above-mentioned any source block BLK_{SOURCE} is valid data. For example, the comparison result may be equal to one of a plurality of predetermined comparison results, and the plurality of predetermined comparison results may comprise:
(1) a first predetermined comparison result: the above-mentioned any P2L address mapping table entry and the corresponding L2P address mapping table entry match each other, where the P2L address mapping relationship indicated by this P2L address mapping table entry and the L2P address mapping relationship indicated by this L2P address mapping table entry are inverse mapping relationships of each other; and
(2) a second predetermined comparison result: the above-mentioned any P2L address mapping table entry and the corresponding L2P address mapping table entry do not match each other, where the P2L address mapping relationship indicated by this P2L address mapping table entry and the L2P address mapping relationship indicated by this L2P address mapping table entry are not inverse mapping relationships of each other;
but the present invention is not limited thereto.

In Step S16, the memory controller 110 may determine whether the data corresponding to the above-mentioned any P2L address mapping table entry in the above-mentioned any source block BLK_{SOURCE} is valid data according to the comparison result. If Yes (e.g., the comparison result is equal to the first predetermined comparison result), proceed to Step S17; If No (e.g., the comparison result is equal to the second predetermined comparison result), proceed to Step S19.

In Step S17, the memory controller 110 may obtain valid-data location information (or “valid-data-location information”) of the data corresponding to the above-mentioned any P2L address mapping table entry, for example, the location information of the data corresponding to the above-mentioned any P2L address mapping table entry in the above-mentioned any source block BLK_{SOURCE}, and more particularly, store the valid-data location information in a corresponding dedicated memory region R_Dedicated among the N_{E} dedicated memory regions {R_Dedicated}, such as the dedicated memory region R_Dedicated of the NV memory element to which the above-mentioned any source block BLK_{SOURCE} belongs.

In Step S18, the memory controller 110 may determine whether the data amount DataSize of the valid data corresponding to the checked P2L address mapping table entries reaches a first predetermined data amount threshold DataSizeTh. If Yes (e.g., DataSize=DataSizeTh), proceed to Step S21; If No (e.g., DataSize<DataSizeTh), proceed to Step S19. For example, the first predetermined data amount may represent the storage capacity of a data region of a destination block BLK_{DESTINATION}, but the invention is not limited thereto. According to some embodiments, the first predetermined data amount may vary, in order to start performing at least one GC operation earlier.

In Step S19, the memory controller 110 may determine whether to continue reading the P2L address mapping table of the above-mentioned any source block BLK_{SOURCE}. If Yes, proceed to Step S13; if No, proceed to Step S20. For example, when the P2L address mapping table of this source block BLK_{SOURCE} has not been fully read (e.g., at least one P2L address mapping table entry in this P2L address mapping table has not been read), the memory controller 110 may execute Step S13 to continue reading the P2L address mapping table, and more particularly, execute at least one portion of steps among Steps S13 to S18 to perform similar operations on the next P2L address mapping table entry in this P2L address mapping table. In another example, when the P2L address mapping table of this source block BLK_{SOURCE} has been fully read (e.g., all P2L address mapping table entries in this P2L address mapping table have been read), the memory controller 110 may execute Step S20 to perform subsequent operations.

In Step S20, the memory controller 110 may determine whether a next source block BLK_{SOURCE} to be checked among the multiple source blocks {BLK_{SOURCE}} exists (labeled “Next BLK_{SOURCE}” for brevity). If Yes, proceed to Step S13; If No, proceed to Step S21. For example, when the multiple source blocks {BLK_{SOURCE}} have not been fully checked (e.g., at least one source block BLK_{SOURCE} among the multiple source blocks {BLK_{SOURCE}} has not been checked, and/or at least one P2L address mapping table of the above-mentioned at least one source block BLK_{SOURCE} has not been read), the memory controller 110 may execute Step S13 to continue checking the multiple source blocks {BLK_{SOURCE}}, and more particularly, execute at least one portion of steps among Steps S13 to S19 to select the next source block BLK_{SOURCE} to be checked and perform similar operations regarding the next source block BLK_{SOURCE} to be checked. In another example, when the multiple source blocks {BLK_{SOURCE}} have been fully checked (e.g., each source block BLK_{SOURCE} among the multiple source blocks {BLK_{SOURCE}} has been checked), the memory controller 110 may execute Step S21 to perform subsequent operations.

As shown in FIG. 8, the memory controller 110 may execute at least one loop comprising at least one portion of steps among Steps S13 to S20, and more particularly, execute Step S13 multiple times to read the respective P2L address mapping table of the multiple source blocks {BLK_{SOURCE}}, execute Step S14 multiple times to read at least one latest L2P address mapping table according to the respective P2L address mapping table of the multiple source blocks {BLK_{SOURCE}}, and execute Step S15 multiple times to compare the respective P2L address mapping tables of the multiple source blocks {BLK_{SOURCE}} with the above-mentioned at least one latest L2P address mapping table to generate multiple sets of comparison results. For example, the above-mentioned at least one latest L2P address mapping table may represent at least one local L2P address mapping table corresponding to the multiple source blocks {BLK_{SOURCE}} among the plurality of local L2P address mapping tables.

The memory controller 110 may compare the respective P2L address mapping tables of the multiple source blocks {BLK_{SOURCE}} with the above-mentioned at least one latest L2P address mapping table to generate and store valid-data location information {INFO_VDL_Dedicated} in the N_{E} dedicated memory regions {R_Dedicated}, respectively, for indicating the locations of the per-NV-memory-element valid data. More particularly, in a situation where the aforementioned at least one NV memory element comprises the plurality of NV memory elements 122-1, 122-2, . . . , and 122-N_{E}, the memory controller 110 may compare the respective P2L address mapping table of the multiple source blocks {BLK_{SOURCE}} and the above-mentioned at least one latest L2P address mapping table to generate and store the valid-data location information {INFO_VDL_Dedicated} in the N_{E} dedicated memory regions {R_Dedicated}, respectively, for indicating the locations of the respective valid data of the plurality of NV memory elements 122-1, 122-2, . . . , and 122-N_{E}, such as the respective locations of all valid data in the multiple source blocks {BLK_{SOURCE}}, respectively.

For example, the valid-data location information {INFO_VDL_Dedicated} respectively stored in the N_{E} dedicated memory regions {R_Dedicated} may comprise multiple sets of valid-data location information corresponding to the plurality of NV memory elements 122-1, 122-2, . . . , and 122-N_{E}., such as the N_{E} sets of valid-data location information {INFO_VDL_Dedicated(1), INFO_VDL_Dedicated(2), . . . , INFO_VDL_Dedicated(N_{E})}. The memory controller 110 may select a dedicated memory region R_Dedicated(n) corresponding to the above-mentioned any NV memory element 122-n (e.g., the die DIE(n) or the chip CHIP(n)) from the N_{E} dedicated memory regions {R_Dedicated}, and generate and store a set of valid-data location information INFO_VDL_Dedicated(n) corresponding to the above-mentioned any NV memory element 122-n among the N_{E} sets of valid-data location information {INFO_VDL_Dedicated(1), INFO_VDL_Dedicated(2), . . . , INFO_VDL_Dedicated(N_{E})} in this dedicated memory region R_Dedicated(n), for indicating the locations of the valid data of all sources blocks {BLK_{SOURCE}} belonging to the above-mentioned any NV memory element 122-n among the multiple source blocks {BLK_{SOURCE}}.

In Step S21, the memory controller 110 may perform multiple GC operations according to the above-mentioned valid-data location information {INFO_VDL_Dedicated} respectively stored in the N_{E} dedicated memory regions {R_Dedicated}, such as the N_{E} sets of valid-data location information {INFO_VDL_Dedicated(1), INFO_VDL_Dedicated(2), INFO_VDL_Dedicated(N_{E})} respectively stored in the dedicated memory regions {R_Dedicated(1), R_Dedicated(2), . . . , R_Dedicated(N_{E})}, where at least one portion of GC operations (e.g., a portion of GC operations or all GC operations) among the multiple GC operations are performed in parallel processing. For example, the plurality of NV memory elements 122-1, 122-2, . . . , and 122-N_{E} may comprise an NV memory element 122-n1 and an NV memory element 122-n2 (e.g., “n1” and “n2” may represent two different integers in the interval [1, N_{E}]), and the above-mentioned at least one portion of GC operations may comprise a first GC operation and a second GC operation respectively corresponding to the NV memory element 122-n1 and the NV memory element 122-n2. More particularly, the memory controller 110 may perform the first GC operation on the NV memory element 122-n1, and perform the second GC operation on the NV memory element 122-n2. Assuming n1=Y and n2=Y for better comprehension, the NV memory element 122-n1 may represent the die DIE(X)/chip CHIP(X), and the NV memory element 122-n2 may represent the die DIE(Y)/chip CHIP(Y), but the invention is not limited thereto.

In the first GC operation, the memory controller 110 may sequentially read first valid data of the NV memory element 122-n1 (e.g., the die DIE(X) or the chip CHIP(X)) according to an n1^{th} set of valid-data location information INFO_VDL_Dedicated(n1) stored in the dedicated memory region R_Dedicated(n1), and write the first valid data into a destination block BLK_{DESTINATION}(n1) belonging to the NV memory element 122-n1. In addition, in the second GC operation, the memory controller 110 may sequentially read second valid data of the NV memory element 122-n2 (e.g., the die DIE(Y) or the chip CHIP(Y)) according to an n2^{th} set of valid-data location information INFO_VDL_Dedicated(n2) stored in the dedicated memory region R_Dedicated(n2), and write the second valid data into a destination block BLK_{DESTINATION}(n2) belonging to the NV memory element 122-n2. For brevity, similar descriptions for this embodiment are not repeated in detail here.

For better comprehension, the method may be illustrated with the working flow shown in FIG. 8, but the present invention is not limited thereto. According to some embodiments, one or more steps may be added, deleted, or changed in the working flow shown in FIG. 8.

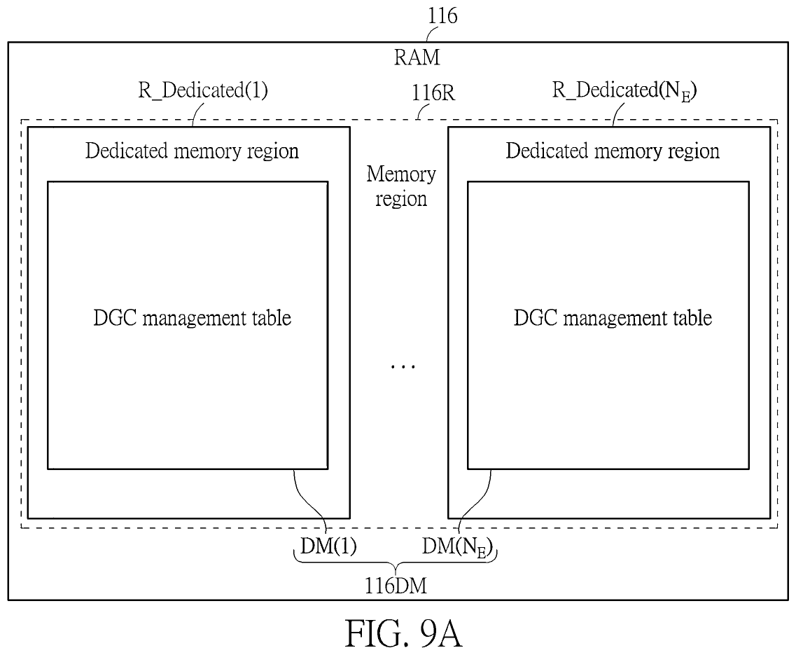

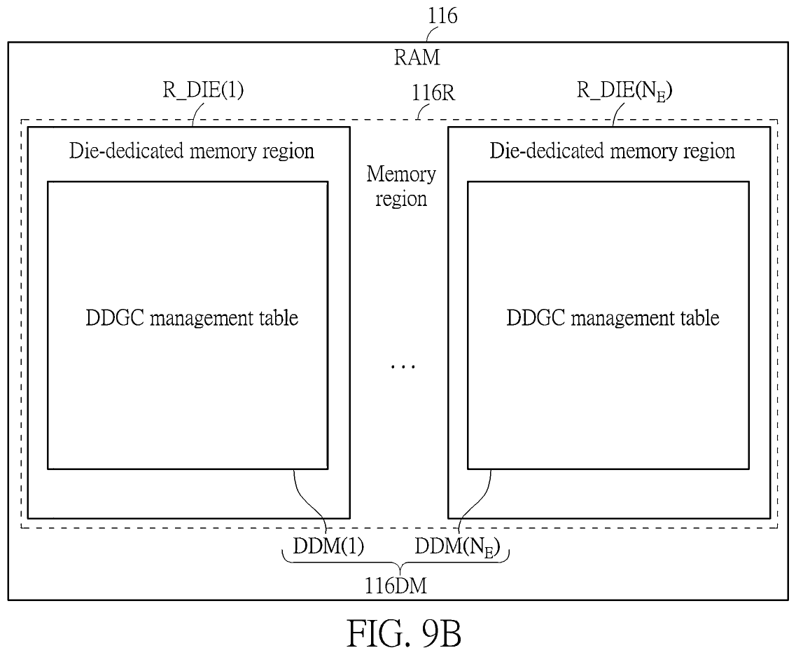

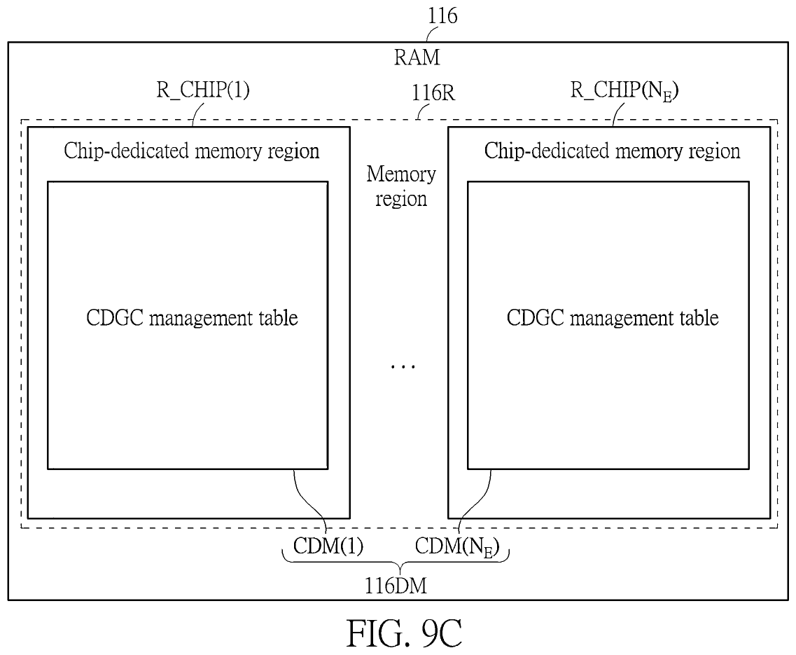

FIG. 9A illustrates an example of the N_{E} dedicated memory regions {R_Dedicated} involved with the method, FIG. 9B illustrates an example of the N_{E} die-dedicated memory regions {R_DIE} involved with the method, and FIG. 9C illustrates an example of the N_{E} chip-dedicated memory regions {R_CHIP} involved with the method. As shown in FIG. 9A, the memory region 116R may comprise the N_{E} dedicated memory regions {R_Dedicated} such as the dedicated memory regions {R_Dedicated(1), . . . , R_Dedicated(N_{E})}, and the memory controller 110 may use the dedicated memory regions {R_Dedicated(1), . . . , R_Dedicated(N_{E})} to store the DGC management tables {DM(1), . . . , DM(N_{E})}, respectively. When the N_{E} dedicated memory regions {R_Dedicated} are implemented as the N_{E} die-dedicated memory regions {R_DIE} such as the die-dedicated memory regions {R_DIE(1), . . . , R_DIE(N_{E})}, the above-mentioned DGC management tables {DM(1), . . . , DM(N_{E})} may also be referred to as the die-dedicated GC (DDGC) management tables, and therefore may be rewritten as the DDGC management tables {DDM(1), . . . , DDM(N_{E})} in FIG. 9B, and the memory controller 110 may use the die-dedicated memory regions {R_DIE(1), . . . , R_DIE(N_{E})} to store the DDGC management tables {DDM(1), . . . , DDM(N_{E})}, respectively. When the N_{E} dedicated memory regions {R_Dedicated} are implemented as the N_{E} chip-dedicated memory regions {R_CHIP} such as the chip-dedicated memory regions {R_CHIP(1), . . . , R_CHIP(N_{E})}, the above-mentioned DGC management tables {DM(1), . . . , DM(N_{E})} may also be referred to as the chip-dedicated GC (CDGC) management tables, and therefore may be rewritten as the CDGC management tables {CDM(1), . . . , CDM(N_{E})} in FIG. 9C, and the memory controller 110 may use the chip-dedicated memory regions {R_CHIP(1), . . . , R_CHIP(N_{E})} to store the CDGC management tables {CDM(1), . . . , CDM(N_{E})}, respectively. For brevity, similar descriptions for this embodiment are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing garbage collection (GC) management of a memory device with aid of dedicated information control, the method being applied to a memory controller of the memory device, the memory device comprising the memory controller and a non-volatile (NV) memory, the NV memory comprising at least one NV memory element, the at least one NV memory element comprising a plurality of blocks, the method comprising:
utilizing the memory controller to receive at least one first command from a host device through a transmission interface circuit within the memory controller, and perform at least one accessing operation on the NV memory according to the at least one first command, wherein the at least one first command indicates at least one write request from the host device; and
executing a GC procedure to start performing GC on the NV memory, wherein the GC procedure comprises:
dividing a memory region of a volatile memory within the memory controller into multiple sub-regions according to a number of the at least one NV memory element to be multiple dedicated memory regions, wherein the number of the at least one NV memory element is greater than one;
selecting multiple source blocks from the plurality of blocks;
reading respective physical-to-logical (P2L) address mapping tables of the multiple source blocks;
reading at least one latest logical-to-physical (L2P) address mapping table within the NV memory according to the respective P2L address mapping tables of the multiple source blocks;
comparing the respective P2L address mapping tables of the multiple source blocks and the at least one latest L2P address mapping table to generate and store valid-data location information in the multiple dedicated memory regions, respectively, for indicating locations of per-NV-memory-element valid data; and
performing multiple GC operations according to said valid-data location information respectively stored in the multiple dedicated memory regions, wherein at least one portion of GC operations among the multiple GC operations are performed in parallel processing.

2. The method of claim 1, wherein the at least one NV memory element comprises a plurality of NV memory elements a plurality of NV memory elements, and the multiple dedicated memory regions represent multiple NV-memory-element-dedicated memory regions respectively corresponding to the plurality of NV memory elements.

3. The method of claim 2, wherein the plurality of NV memory elements represent a plurality of flash memory dies, and the multiple dedicated memory regions represent multiple die-dedicated memory regions respectively corresponding to the plurality of flash memory dies.

4. The method of claim 2, wherein the plurality of NV memory elements represent a plurality of flash memory chips, and the multiple dedicated memory regions represent multiple chip-dedicated memory regions respectively corresponding to the plurality of flash memory chips.

5. The method of claim 1, wherein the memory controller is arranged to write host data from the host device into at least one block among the plurality of blocks, and correspondingly update a global L2P address mapping table in the NV memory, for indicating mapping relationships from logical addresses to physical addresses, wherein the global L2P address mapping table is divided into a plurality of local L2P address mapping tables; and the at least one latest L2P address mapping table represents at least one local L2P address mapping table corresponding to the multiple source blocks among the plurality of local L2P address mapping tables.

6. The method of claim 1, wherein the at least one NV memory element comprises a plurality of NV memory elements; and comparing the respective P2L address mapping tables of the multiple source blocks and the at least one latest L2P address mapping table to generate and store said valid-data location information in the multiple dedicated memory regions, respectively further comprises:
comparing the respective P2L address mapping tables of the multiple source blocks and the at least one latest L2P address mapping table to generate and store said valid-data location information in the multiple dedicated memory regions, respectively, for indicating locations of respective valid data of the plurality of NV memory elements, respectively.

7. The method of claim 6, wherein said valid-data location information respectively stored in the multiple dedicated memory regions comprises multiple sets of valid-data location information corresponding to the plurality of NV memory elements; and the memory controller is arranged to select a dedicated memory region corresponding to any NV memory element of the plurality of NV memory elements from the multiple dedicated memory regions, and generate and store a set of valid-data location information corresponding to the any NV memory element among the multiple sets of valid-data location information in the dedicated memory region, for indicating locations of valid data of all source blocks belonging to the any NV memory element among the multiple source blocks.

8. The method of claim 1, wherein the at least one NV memory element comprises a plurality of NV memory elements, the plurality of NV memory elements comprise a first NV memory element a second NV memory element, and the at least one portion of the GC operations comprise a first GC operation and a second GC operation respectively corresponding to the first NV memory element and the second NV memory element; and
the memory controller is arranged to perform the first GC operation on the first NV memory element, and perform the second GC operation on the second NV memory element.

9. The method of claim 8, wherein in the first GC operation, the memory controller reads first valid data of the first NV memory element according to a first set of valid-data location information stored in a first dedicated memory region, and writes the first valid data into a first destination block belonging to the first NV memory element; and in the second GC operation, the memory controller reads second valid data of the second NV memory element according to a second set of valid-data location information stored in a second dedicated memory region, and writes the second valid data into a second destination block belonging to the second NV memory element.

10. The method of claim 8, wherein said valid-data location information respectively stored in the multiple dedicated memory regions comprises multiple sets of valid-data location information corresponding to the plurality of NV memory elements, wherein the multiple sets of valid-data location information comprise a first set of valid-data location information corresponding to the first NV memory element and a second set of valid-data location information corresponding to the second NV memory element, and the first set of valid-data location information and the second set of valid-data location information are stored in a first dedicated memory region and a second dedicated memory region among the multiple dedicated memory regions, respectively.

11. A memory controller of a memory device, the memory device comprising the memory controller and a non-volatile (NV) memory, the NV memory comprising at least one NV memory element, the at least one NV memory element comprising a plurality of blocks, the memory controller comprising:
a processing circuit, arranged to control the memory controller according to a plurality of host commands from a host device, to allow the host device to access the NV memory through the memory controller, wherein the processing circuit is arranged to perform garbage collection (GC) management of the memory device with aid of dedicated information control; and
a transmission interface circuit, arranged to perform communications with the host device; wherein:
the memory controller receives at least one first command from the host device through the transmission interface circuit within the memory controller, and performs at least one accessing operation on the NV memory according to the at least one first command, wherein the at least one first command indicates at least one write request from the host device; and
the memory controller executes a GC procedure to start performing GC on the NV memory, wherein the GC procedure comprises:
dividing a memory region of a volatile memory within the memory controller into multiple sub-regions according to a number of the at least one NV memory element to be multiple dedicated memory regions, wherein the number of the at least one NV memory element is greater than one;
selecting multiple source blocks from the plurality of blocks;
reading respective physical-to-logical (P2L) address mapping tables of the multiple source blocks;
reading at least one latest logical-to-physical (L2P) address mapping table within the NV memory according to the respective P2L address mapping tables of the multiple source blocks;
comparing the respective P2L address mapping tables of the multiple source blocks and the at least one latest L2P address mapping table to generate and store valid-data location information in the multiple dedicated locations of memory regions, respectively, for indicating per-NV-memory-element valid data; and
performing multiple GC operations according to said valid-data location information respectively stored in the multiple dedicated memory regions, wherein at least one portion of GC operations among the multiple GC operations are performed in parallel processing.

12. The memory device comprising the memory controller of claim 11, wherein the memory device comprises:
the NV memory, configured to store information; and
the memory controller, coupled to the NV memory, configured to control operations of the memory device.

13. An electronic device comprising the memory device of claim 12, and further comprising:
the host device, coupled to the memory device, wherein the host device comprises:
at least one processor, arranged for controlling operations of the host device; and
a power supply circuit, coupled to the at least one processor, arranged for providing power to the at least one processor and the memory device;
wherein the memory device provides the host device with storage space.
